(19) United States
(12) Patent Application Publication
(10) Pub. No.: US 2024/0349661 A1
(43) Pub. Date: Oct. 24, 2024

(54) SYSTEM FOR DETERMINING PARAMETER SETTINGS FOR AN ENCLOSED GROWING ENVIRONMENT

(71) Applicant: c/o Heliponix, LLC, Evansville, IN (US)

(72) Inventors: Ivan Lee Ball, Owensville, IN (US); Scott Thomas Massey, Evansville, IN (US)

(21) Appl. No.: 18/685,556

(22) PCT Filed: Aug. 23, 2022
(86) PCT No.: PCT/US22/75318

§ 371 Date: Feb. 22, 2024

Related U.S. Application Data
(60) Provisional application No. 63/236,505, filed on Aug. 24, 2021.

(51) Int. Cl. A01G 9/26; G06Q 50/02; H04L 67/12

(52) U.S. Cl. CPC A01G 9/26; G06Q 50/02; H04L 67/12

(57) ABSTRACT

A cloud based management system for indoor growing appliances. The managed system may be configured to monitor multiple appliances output, yields, and food quality and to adjust individual appliance growth conditions to improve the output, yields, and food quality.

### CROSS-REFERENCE TO RELATED APPLICATIONS

This application is a U.S. national stage application under 35 USC § 371 of International Application No. PCT/US22/75318 filed on Aug. 23, 2022 and entitled “SYSTEM FOR DETERMINING PARAMETER SETTINGS FOR AN ENCLOSED GROWING ENVIRONMENT, which claims priority to U.S. Provisional Application No. 63/236,505, filed on Aug. 24, 2021 and entitled “SYSTEM FOR DETERMINING PARAMETER SETTINGS FOR AN ENCLOSED GROWING ENVIRONMENT,” the entire contents of which are incorporated herein by reference.

### BACKGROUND

Home gardening and usage of micro gardens in the apartment complexes and neighborhoods has grown in recent years throughout the United States in response to food deserts limiting the availability of fresh produce in densely populated areas. More consumers desire to have fresh produce and herbs grown at home to provide fresher produce, as well as to limit the preservatives and chemicals used in large grocery stores. Depending on climate, homeowners may be limited to indoor systems for growing fresh produce and herbs. However, most indoor systems are limited in space and provide unitary growing conditions for all produce and herbs that often results in suboptimal conditions for all produce and herbs being produced by the homeowner. Additionally, homeowners often lack the education and time to properly maintain optimal growth conditions for each individual species and type of plant.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a management system for determining parameters for plants associated with an enclosed growing environment or appliance.

FIG. 2 is an example block diagram of an architecture of a management system for determining parameters for plants associated with an enclosed growing environment or appliance.

FIG. 3 is an example block diagram of an architecture associated with a management system for determining parameters associated with an enclosed growing environment or appliance.

FIG. 4 is an example block diagram of an architecture associated with a management system for determining parameters associated with an enclosed growing environment or appliance.

FIG. 5 is an example flow diagram showing an illustrative process for updating a policy or configuration associated with the management system according to some implementations.

FIG. 6 is an example flow diagram showing an illustrative process for updating ordering instructions associated with the management system according to some implementations.

FIG. 7 is an example flow diagram showing an illustrative process for updating parameters associated with the management system according to some implementations.

FIG. 8 is an example diagram of a cloud-based service associated with the management system according to some implementations.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Discussed herein are systems and methods associated with automating, optimizing, and customizing parameters for controlling an at home enclosed growing appliance (such as a micro garden). For example, a management system may be communicatively coupled to one or more enclosed growing appliances. As discussed herein, the appliances may, in some implementations, provide an isolated enclosure that is configured to provide stable and controlled environmental conditions, physically separated from the conditions within surrounding environment (e.g., the home or apartment, and the like). For example, the appliance may include a planting column or tower within the enclosure. The planting column may comprise a plurality of receptacles configured to receive individual cartridges. The planting receptacles may be arranged both in vertical columns and horizontal rows about the planting column. For instance, in one specific example, the planting column may include twenty columns and five rows of planting receptacles. In some cases, the planting receptacles may be staggered between the columns, such at each column has one planting receptacle for every other row. In these cases, staggering the planting receptacles allows the appliance to be able to monitor each individual plant as well as allowing each individual plant sufficient room to grow.

In some cases, the receptacles may be pre sized in order to receive pre-prepared and/or pre-packaged seed cartridges. In this manner, a user may insert a cartridge into a receptacle as a simple and streamlined planting process. The seed cartridges may in some cases be cartridges with the seeds for the desired plants, fertilizer, and other media (such as a growth media). The seed cartridges may be of uniform size and dimensions and may include openings for receiving water and other nutrition via the planting column.

In some implementations, the management system may be configured to receive sensor data (such as temperature data, image data, air quality data, light data, water quality data, and the like associated with the appliance) from the individual appliances, user inputs and settings from user devices associated with the owners of the appliances, cartridge data (such as plant type, cartridge manufacturer, cartridge facility, date planted, and the like) associated with the plants being grown or inserted into the appliances, as well as third party data. The management system may then utilize the received data to determine growing parameters for each of the individual appliances and/or for each of the individual cartridges or plants within the appliances.

For example, the enclosed growing appliance may be configured to provide an enclosed growing environment for at home and indoor cultivation of plants and fungi, flowers, fruits, vegetables, produce, mushrooms, and/or herbs. The system may, in some implementations, provide an isolated enclosure that is configured to provide stable and controlled environmental conditions, physically separated from the conditions within the surrounding environment (e.g., the home or apartment). However, unlike conventional home garden systems that provide uniform lighting and temperature, the enclosure discussed herein may provide active monitoring (e.g., sensor data collection) and adaptive environmental conditions (based on the parameters received from the management system).

In some specific implementations, the management system may be configured to monitor individual plants within the growing environment by processing (e.g., segmenting, classifying, clustering, and the like) the sensor data received from each individual appliance. In this manner, the management system may determine the location, size, health, stage of growth, type or species, and the like of individual plants within an appliance. The management system may also store or determine preferences of the user or users associated with the appliance, such as plant taste, size, types, recipes, seasonings, cooking or preparation styles, food pairings, and the like based, for instance, on user data or inputs received via a user device and an associated downloadable application or web hosted application.

The management system may also determine characteristics of the specific plants inserted into the appliance based on the cartridge data received from one or more third party systems. In some cases, the cartridge data may include a chain of custody, such as via block chain, such that the lifecycle of each cartridge may be monitored. For instance, the growing facility, the packaging facility, the transportation or shipping, the sales locations, and the delivery location may all be tracked as the seeds/cartridge moves from one location to the next. In some implementations, the management system may, via the cartridge data, track historical data associated with plants originating from different facilities. In some cases, one family of plants harvested or grown in a particular facility may perform better (e.g., grow faster or larger, have better color, have more desirable or pounced taste, etc.) and the management system may track the facility location or plant family using the cartridge data together with the sensor data received from an appliance hosting the plant and/or user data from a user consuming the plant. In some cases, the management system may also detect and/or determine characteristics of seed cartridges using the captured sensor data, for example, codes, images, or icons present on the cartridges (detected during or after insertion), color changes of the cartridges, temperatures of the cartridges, and the like.

In some specific examples, the sensor data may also include environmental data (e.g., temperature, humidity, air quality, lighting, water, and the like) associated with the physical environment outside the enclosure of the appliance. In these examples, the management system may also utilize third party outside environmental data to determine global and/or local policies and/or parameters associated with appliances and/or plants. In some cases, the outside environmental data may also be received from a smart and/or IoT enabled device within the environment, such as smart thermostat, smart lights, smart fire detectors, and/or other IoT enabled system within the outside environment.

In one specific example, the management system may utilize the cartridge data together with associated plant growth data determined from the sensor data provided by the appliance to track an expected germination rate of cartridges from specific facilities, suppliers, growers, and/or manufacturers. For example, the manufacturers may provide or agree to an expected germination rate when engaging to provide cartridges to appliance users on behalf of the management system. In this example, the management system may determine an actual germination rate for the cartridges produced by the specific facilities, suppliers, growers, and/or manufacturers and determine if the specific facilities, suppliers, growers, and/or manufacturers meet or exceed the expected germination rate. If a specific facility, suppliers, grower, and/or manufacturer did not meet or exceed the expected germination rate, the specific facility, suppliers, grower, and/or manufacturer may be alerted (such as via a periodic report) to the loss and an additional number of cartridges that the specific facility, suppliers, grower, and/or manufacturer is expected to deliver under the agreed to terms. In some cases, the management system may also determine specific facilities, suppliers, growers, and/or manufacturers to continue, renew, expand, or reduce orders from based on the determined germination rates (e.g., facilities with higher than expected germination rates may be requested to increase production while facilities with lower than expected germination rates may be requested to reduce production).

In the implementations discussed above, the management system may generate global (e.g., across appliances) and/or local (e.g., per appliance or per cartridge location) policies and parameters to improve the output, yields, food quality, ease of use, and general user experience associated with owning and utilizing an appliance, discussed herein. For example, by processing the sensor data, user data, cartridge data, and/or other third party data, the management system may generate and provide tailored growing conditions, such as custom lighting (e.g., length of exposure, focal length, temperature, specific wavelengths, intensity, amount, and the like), temperature, humidity, water, and the like for individual appliances and/or individual plants within a specific appliance.

In one specific example, the system may also use machine learned models or networks to perform object detection and classification on the plants, determine parameters or settings, generate policies, and the like. For instance, the one or more neural networks may generate any number of learned inferences or heads. In some cases, the neural network may be a trained network architecture that is end-to-end. In one example, the machine learned models may include segmenting, clustering, and/or classifying extracted deep convolutional features of the sensor data into semantic data (e.g., rigidity, light absorption/reflectance, color, health, life stage, etc.). In some cases, appropriate truth outputs of the model in the form semantic per-pixel classifications (e.g., foliage, stem, fruit, vegetable, bug, decay, etc.).

In one specific example, the network architecture that is end-to-end may be a Convolutional Neural Network (CNN) that receives multiple inputs and outputs an end result, such as updated policies, recommended recipes, recommended plants purchases or seed cartridges, placed orders to various third parties (e.g., growers, cartridge manufacturers, and the like). In some cases, the input to the end-to-end network may include third party data, seed cartridge data, user data from one or more users (e.g., user preferences, user specific settings, and the like), appliance data or sensor data from one or more appliances (e.g., environmental data interior and exterior to the appliance, plant data, image data, active receptacles or receptacles containing seed cartridges, and the like), and the like. For instance, in one implementation, the management system may input the user specific data (e.g., user data and appliance data associated with a specific user) together with current third party data into a trained end-to-end network that outputs as multiple heads one or more of plant health data, orders for produces (such as seed cartridges), recommendations to the user (e.g., setting adjustments, harvesting, plant selections, and the like), and the like. It should be understood that the outputs of the end-to-end network may be directed, provided, or sent to various parties including suppliers, growers, user electronic devices, appliances, manufacturers, point of sales systems, and the like.

In some cases, based on the policies and parameters determined, the management system may be configured to place orders on behalf of or for users associated with different appliances. For example, if a user appears to prefer one supplier over another or one type of plant over another (e.g., one type of lettuce over another type of lettuce), the management system may update or change the supplier to select the supplier that the user is determined to prefer.

In some specific examples, the management system may utilize a multi-arm bandit technique to generate parameters, settings and/or policies based on the received data, as discussed above, and one or more control parameters. In other cases, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions (Naïve Bayes), color analyzing or processing techniques and/or a combination thereof.

As described herein, an exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine learning, which can refer to a broad class of such algorithms in which an output is generated based on learned parameters.

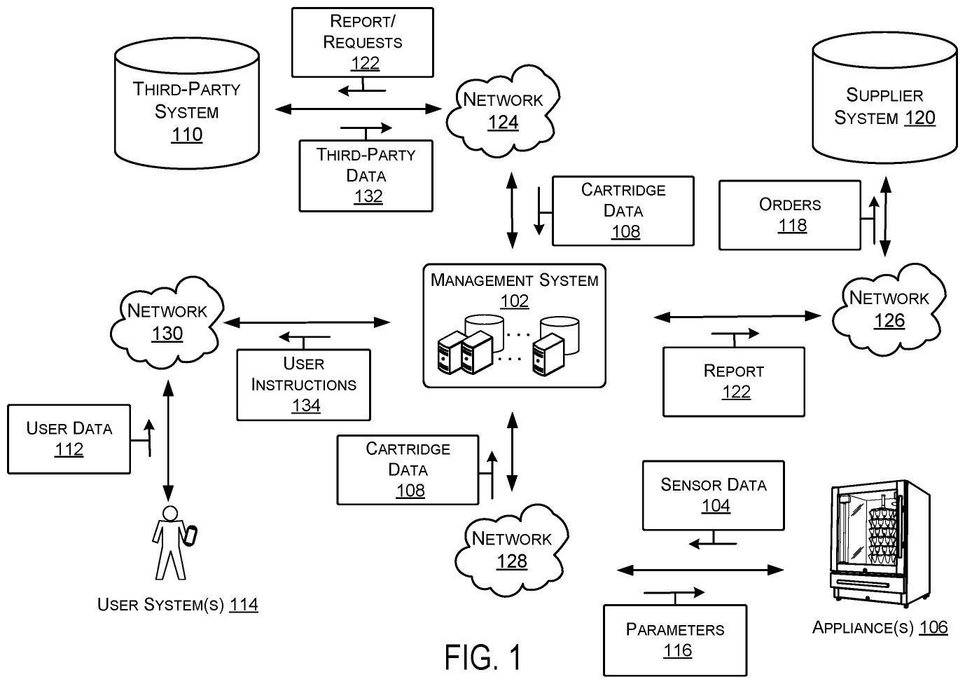

FIG. 1 is an example block diagram of a management system 102 for determining parameters for plants associated with an enclosed growing environment or appliance. In the current example, the management system 102 may receive sensor data 104 from the appliances 106, cartridge data 108 from the appliances 106, the supplier system 120 (e.g., manufactures, growers, assembly contractors, parts suppliers, and the like), and/or other third-party systems 110, and user data 112 from one or more users 114. As discussed above, the sensor data 104 may include temperature data, image data, light data, and the like associated with the appliance 106. In some cases, the sensor data 104 may also include water data, such as incoming water supply quality data, sequestered water data (e.g., water being sequestered by the appliance 106 prior to introduction into the recirculating water supply-to, for instance, remove heavy metals and the like), and the dispensed or recirculating water data. The sensor data 104 may also include air quality data that may include multiple stages of air, such as incoming air supply quality data, sequestered air data (e.g., air being sequestered by the appliance 106 prior to introduction into the appliance air supply), and the dispensed or recirculating air data.

The user data 112 may include settings from user devices associated with the user 114, such as preferences of the user 114 (e.g., plant taste, plant color, leaf size at consumption, plant age or life cycle at consumption, and the like), desired plant size, desired plant types (species or family), favorite recipes, favorite seasonings, cooking or preparation styles, food pairings, and the like. The user data 112 may include data from third party applications 110 (social media applications, marketplaces applications, smart home applications, and the like) associated with the user 114, such as details of the user 114 (e.g., family size, culture, age, location, etc.). The cartridge data 108 may include plant species, family, expected germination rate, growing facility, date planted, date of seed insertion, date of cartridge placement in an appliance 106, and the like.

In some examples, the management system 102 may also receive third-party data 132 from the third-party applications 110. The third-party data 132 may include research data, marketplace data, smart home data (e.g., pantry or storage data, environmental data, smart appliance data, and the like), health data, genetic data, historical data, mark sales data, advertising data, monetary exchange data, government data, social media data, web-crawler data, agricultural partners, insurance data, complementary food data, meal kit planning, grocery data, customer data, subscription data among other types of data.

The third-party applications and systems 110 may include companies, university, research facilities, other growers, social media, government agencies, marketplaces, delivery systems, ordering systems, health systems, wearable systems, and the like. For example, the management system 102 may utilize third-party data from a smart appliance and the sensor data 104 to send a report/requests 122 to a grocery delivery system (e.g., a second third-party system 110). In this example, the report/requests 122 may include an order for delivery of food that may compliment the plants that are in a near harvesting condition. In some specific examples, the report/requests 122 may include a specific delivery date to coincide with an optimal data of harvesting. As another illustrated example, the third-party data 132 may include individual and/or aggregated (and depersonalized) health data. The management system 102, in this example, may utilize the health data to determine dietary suggestions and/or parameters 116 for the appliance 106 to improve, for instance, a vitamin C deficiency in an individual. In some cases, the management system 102 may include orders for plants that have particular nutritional benefits based on the health data when sending the report/request 122 to the third-party systems 110.

The management system 102 may then utilize the received data 104, 108, and 112 as well as historical and/or aggregate data (such as by plants, conditions, appliances and the like) to determine growing policies and parameters 116 for each of the individual appliances 106 and/or for each of the individual cartridges or plants within the appliance 106. In some specific implementations, the management system 102 may be configured to monitor individual plants within the growing environment by processing (e.g., segmenting, clustering, classifying, and the like) the sensor data 104. For example, the management system 102 may determine the location, size, health, stage of growth, type or species, and the like of individual plants within an appliance 106. The management system 102 may also determine characteristics of the specific plants inserted into the appliance 106. In this manner, using the sensor data 104, the management system 102 may determine the characteristics and features of the plants as the plants grow within the appliance 106.

The management system 102 may then utilize the cartridge data 108 together with the characteristics and features of the plants in multiple appliances to update and/or determine policies and/or parameters 116 (e.g., lighting, humidity, temperature, water, and the like) for each individual plant within the appliance 106. In some cases, the management system 102 may aggregate the sensor data 104 over multiple appliances located within a given geographic region, with similar outside environmental conditions (e.g., the conditions outside the enclosure of the appliance 106 are within a threshold values), with similar interior environmental conditions (e.g., the conditions inside the enclosure of the appliance 106 are within a threshold values, such as the same plants, similar plant arrangements, cartridges are from the same supplier, grower, facility, manufacturer, and/or geographic region, and the like), and the like.

As the management system 102 determines that different plants, families of plants, placement of plants within the appliance 106, and the like, perform better and/or are healthier under specific conditions, the management system 102 may update or adjust policies, configurations, and/or parameters 116 that control the features and/or growing conditions of the appliance 106.

In some cases, the management system 102 may operate by generating a mirror setting system and/or simulation of a specific appliance 106. In this manner, the management system 102 may test or simulate performance of plants with various parameters 116 and/or configurations prior to applying them globally to multiple different appliances having matching criteria (e.g., plants, conditions, and the like) and/or to the mirrored appliance 106.

In one specific example, the management system 102 may utilize the cartridge data 108 together with the sensor data 104 provided by the appliance 106 to track an expected germination rate or other performance metric associated with individual cartridges. For example, as discussed above, a supplier, grower, and/or manufacture may provide or agree to an expected germination rate or yield rate when engaging to provide cartridges to appliance users 114 on behalf of the management system 102. In this example, the management system 102 may determine an actual germination rate or yield rate for the cartridges produced by the supplier (e.g., grower, manufacturer of the cartridges, assembler, seed source, a combination thereof, or the like). The management system 102 may then determine if the supplier met or exceeded the expected germination rate and/or yield rate. If the supplier did not meet or exceed the expected germination rate and/or yield rate, the management system 102 may alert the supplier, via the supplier system 120, the user, and/or another responsible party, such as via third party system 110. In some cases, the management system 102 may also adjust cartridge order rates based on the actual germination rate and/or yield rate that is determined from the sensor data 104 and/or the cartridge data 108.

In some cases, based on the policies and parameters 114 and the user data 112, the management system 102 may be configured to place orders 118 on behalf of or for users 114 associated with different appliances 106 at one or more supplier system 120. For example, if a user 114 appears to prefer one supplier over another or one type of plant over another (e.g., one type of lettuce over another type of lettuce), the management system 102 may update or change the supplier to select the supplier that the user 114 is determined to prefer.

In some specific example, the management system 102 may determine from sensor data 104 from the appliance 106 a rate of consumption or a rate of harvest of plants within the appliance 106. The management system 102 may then adjust standing orders (such as weekly orders, monthly orders, quarterly orders, or the like) based on the rate of harvest. In some cases, based on the type of plants harvested, the management system 102 may adjust the order amounts, plant mixes, and the like. For instance, if a user appears to favor kale over spinach, the system 102 may increase the cartridge order of kale while likewise reducing the order for spinach cartridges. In some cases, the management system 102 may also order new types of plants based on similar flavor profiles and/or on a consumption or harvesting patterns (such as over a period of a prior week, month, quarter, etc.). In this manner, the management system 102 may present each user with additional plants having different nutritional and taste profiles that have a higher likelihood of enjoyment by the user than other randomly selecting or suggesting new plants.

In some cases, the management system 102 may determine policies that require at least in part user action. For example, the management system 102 may determine optimal cartridge placement within the appliance 106 for each type of plant. In these cases, the user 114 may be required to place or insert the cartridge accordingly. In these cases, the management system 102 may also generate user instructions 134 to instruct the user via, for instance, a downloadable application hosted on a user electronic device to insert specific cartridges at specific locations within the appliance 106.

In some examples, the management system 102 may generate reports 122 including, for example, cartridge yield rates or germination rates, appliance metrics associated with individual appliances, such as appliance 106, to other aggregate data, such as aggregate user data 112 and the like. In the illustrated example, the reports 122 may be provided to supplier systems 120 as well as third party systems 110.

In some cases, the management system 102 may also track multiple cartridges for each appliance 106. The management system 102 in addition to determining the supplier, manufacture, and/or grower may determine a total number and/or type of cartridge for each cartridge in each appliance. In some cases, the total number and/or types of cartridges may be included in the reports 122.

In the current example, the sensor data 104, cartridge data 108, third party data 130, orders 118, user instructions 134, and/or reports 122 may be sent and/or received by the management system 102 via various networks, such as networks 124-130.

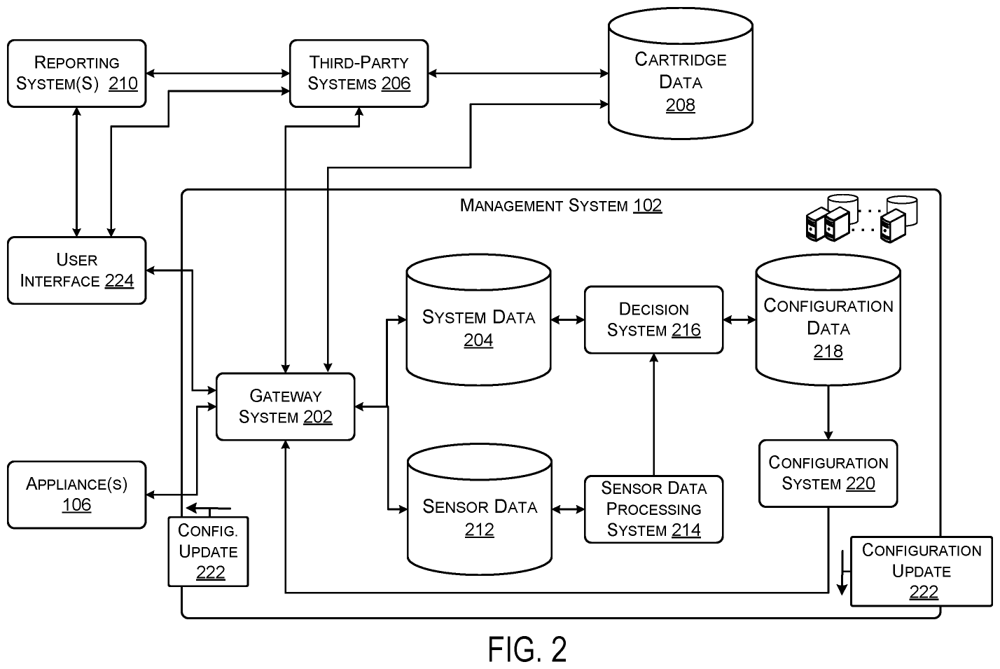

FIG. 2 is an example block diagram of an architecture 200 of a management system, such as management system 102 of FIG. 1, for determining parameters for plants associated with an enclosed growing environment or appliance. In the current example, the management systems 102 may be configured to receive user data from a user interface 224 (such as a web-based application and/or downloadable application) at a gateway system 202. The user data may be stored, at least in part as system data 204. In some cases, the system data 204 may also include third party data received from one or more third party systems 206, cartridge data 208 received from various systems in communication with or proximity to the actual seed cartridges, sales data associated with one or more sales, business, CRM, ERP, or reporting system 210.

The management system 102 may also receive, via the gateway 202, sensor data 212 from one or more appliances, such as appliances 106. As discussed above, the sensor data may include temperature data, image data, air quality data, light data, water data, and the like associated with the appliance 106. In the current example, the sensor data 212 may be processed by a sensor data processing system 214 or computer vision system/engine. In this example, the sensor data processing system 214 may segment, classify, or otherwise extract data, features, characteristics, and the like from the sensor data 212.

The extracted data may then be processed together with the system data 204 by a decision system 216. The decision system 216 may also access a datastore housing configuration data 218. In this example, the decision system 216 may update the configuration data 218 based on the system data 204, the extracted data, and one or more machine learned models or networks. For example, the decision system 216 may apply a multi-arm bandit technique to the received data in order to update the configuration data 218 to assist with improving the overall yield, output, and quality of the plants grown in the appliances 106 to meet the user preference data requirements.

A configuration system 220 may provide updated policies 222 to the appliances 106 via a push notification service as illustrated. In some cases, the updated policies 222 may be global, regional, as a set of similar users, per appliance 106, per plant or receptacle within each appliance 106, and/or a combination thereof. Thus, in some cases, the updated policies 222 may be customized for the individual user and appliance 106, while in other cases, the updated policies 222 may be over a set, multiple related sets, or even all networked appliances 106.

In some cases, the configuration system 220 may utilize one or more machine learned models or networks to determine the configuration update 222. For example, the configuration system 220 may store a mirror copy of the settings and state of each appliance 106 (e.g., the state of individual plants, the environment within and exterior to the appliance 106, and the like). The mirror copy and any proposed or suggested updates by the decision system 216 may be input into the machine learned models and/or networks and the configuration system 220 may receive configuration updates 222 as an output, as discussed below with respect to FIG. 2.

Appliances 106 could be organized into groups based on plant varieties, geographical locations, user preferences, third party systems 110, or any other configurations of the 102 and sensor data. Groupings could receive configuration updates 222 from the management system 102 to automatically update from the decision engine, manually update from the business reporting system, or never update and keep the default control parameters. Custom groupings could be manually created by components of the system 102 (such as a business application) or be automatically created, assigned to a grouping or even multiple groupings. Software/firmware updates could be pushed to target groupings. New cartridge/plant varieties could be offered to target groupings.

In some cases, the groupings may have multiple layers. The first layer may include if the appliance 106 is part of a manual configuration or an automatic configuration. In this case, the automatic configuration may utilize the default configurations and/or any generated configuration updates 222. The system 102 may also have a second layer that may include segmentation groupings. The segmentation groupings may be based on geographic regions, environmental conditions, stage of plant growth, plant types, similarity in user preferences, and the like. For example, the second layer may include grouping a set of appliances 106 to have shared configuration updates 222 based on the various segmentations discussed above. In some cases, the system 102 may alter or update groupings, particularly second layer groupings, on a periodic basis or in response to a detected change (such as a harvest or cartridge insertion event).

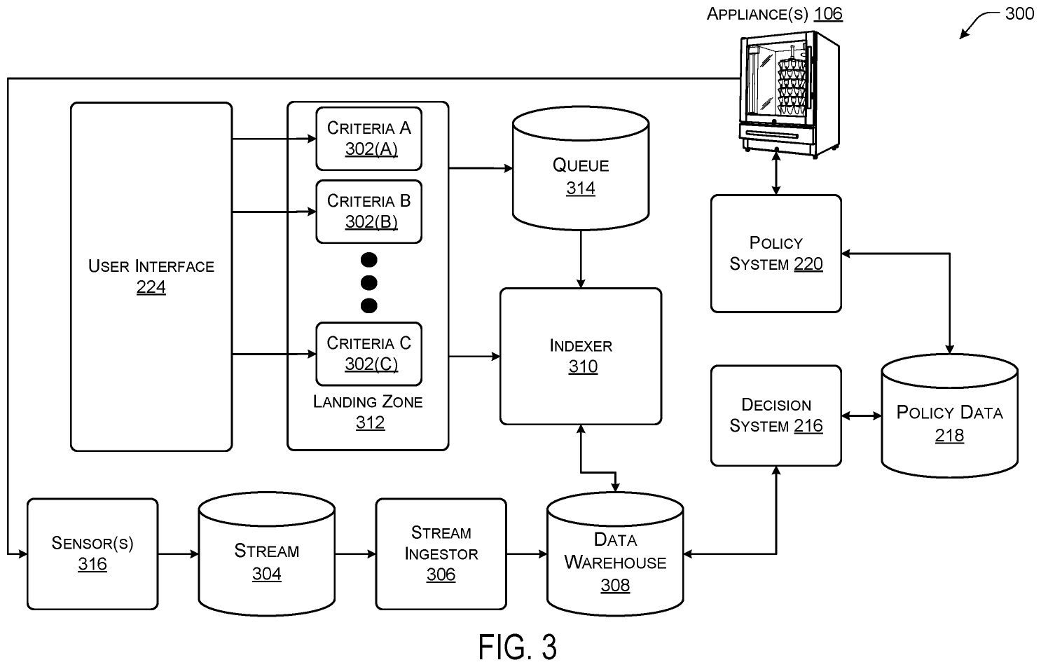

FIG. 3 is an example block diagram of an architecture 300 associated with a management system, such as management system 102, for determining parameters for plants associated with an enclosed growing environment or appliance 106. In the current example, the management system may receive, via a user interface 224, user inputs associated with one or more criteria, generally indicated by 302. The criteria 302 may include preferences of the user associated with, for example, water, algae, harvesting, tissue metrics, size, nutrition, water level setpoint, water valve open time, water valve open frequency, pump frequency, pump on time, grow light on time, grow light intensity, temperature setpoints, tower rotation speed, tower rotation time, UV light on time, device telemetry upload/download frequency, and the like. The criteria 302 may be processed by a landing zone 312 which is output to a queue 314 and an indexer 310, as shown.

The management system also receives data from one or more sensors 316 via a stream 304 at a stream ingestor 306. The output of the stream ingestor 306 may be stored in a data warehouse 308. The data warehouse 308 may also store the output of the indexer 310. In the current example, the data warehouse 308 is accessible and updatable by the decision system 216 which may utilize data stored at the data warehouse 308 to update the configuration data 218. The configuration system 220 may then generate policies and parameters, as discussed above, and output the policies and parameters to one or more appliance 106.

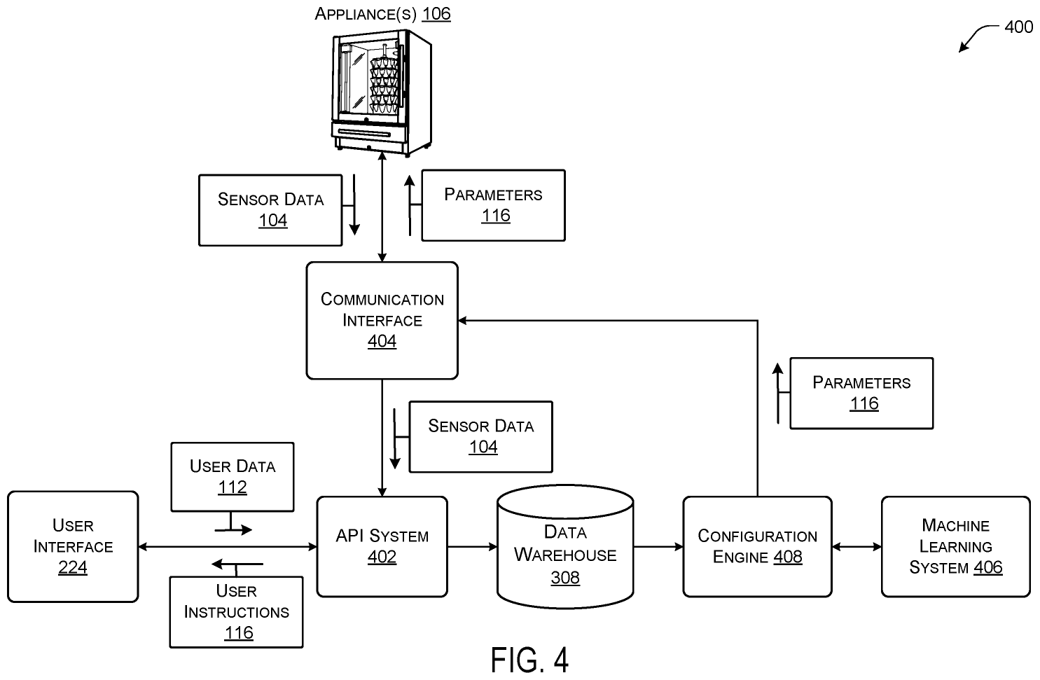

FIG. 4 is an example block diagram of an architecture 400 associated with a management system for determining parameters 116 an enclosed growing environment or appliance 106. In some cases, the management system may monitor and adjust parameters 116 associated with one or more growing appliance 106 to optimize or improve the yields, growing conditions, and energy/water consumption of the appliance 106 as conditions and plants within the enclosed environment of the appliance 106 are adjusted, harvested, and otherwise change.

In the current example, the management system may include an application programming interface 402 configured to receive sensor data 104 from the growing appliance 106 via a communication interface 404, such as an internet of things (IOT) enabled core, processor, and/or antenna. The API system 402 may be configured to also receive user data 112 from a user interface 224, such as a web or app accessible user interface 224. As discussed above the sensor data 104 may include temperature data, image data, light data, and the like associated with the appliance 106. In some cases, the sensor data 104 may also include water data, such as incoming water supply quality data, sequestered water data (e.g., water being sequestered by the appliance 106 prior to introduction into the recirculating water supply-to, for instance, remove heavy metals and the like), and the dispensed or recirculating water data. The sensor data 104 may also include air quality data that may include multiple stages of air, such as incoming air supply quality data, sequestered air data (e.g., air being sequestered by the appliance 106 prior to introduction into the appliance air supply), and the dispensed or recirculating air data.

The user data 112 may include settings from user devices associated with the user, such as preferences of the user (e.g., plant taste, plant color, leaf size at consumption, plant age or life cycle at consumption, and the like), desired plant size, desired plant types (species or family), favorite recipes, favorite seasonings, cooking or preparation styles, food pairings, and the like. The user data 112 may include data from third party applications (e.g., social media applications, marketplaces applications, smart home applications, and the like that the user has authorized the management system to access and/or communicate with) associated with the user 114.

The parameters 116 may include lighting settings, humidity settings, temperature settings, water delivery settings, and the like. In some cases, the parameters 116 are set for each individual receptacle and plant combination within the growing appliance 106 to tailor the plant growth for the individual user based on the user data 112.

In the current example, the API system 402 may store the sensor data 104 and the user data 112 in a data warehouse 308. The data warehouse 308 may be accessible by a configuration engine 408 (such as including the decision system 216, configuration system 220, and the like from FIG. 3). The configuration engine 408 may be configured to determine the parameters 116 for each receptacle of the appliance 106 based at least in part on the pant or cartridge associated with the receptacle, the user data 112, and/or the sensor data 104. In the current example, the configuration engine 408 may provide at least a portion of the user data 112, the sensor data 104, as well as other data (such as criteria, cartridge data, aggregate data, and the like) into one or more machine learning systems 406 (e.g., one or more machine learned models and/or networks). The configuration engine 408 may then receive as an output of the machine learning system 406 the parameters 116 and/or additional data usable to determine the parameters 116. In some case, the machine learned models and/or networks of the machine learning system 406 may be trained using sensor data 104, user data 112, cartridge data, third party data, and/or other data associated with one or more appliances over a prior period of time.

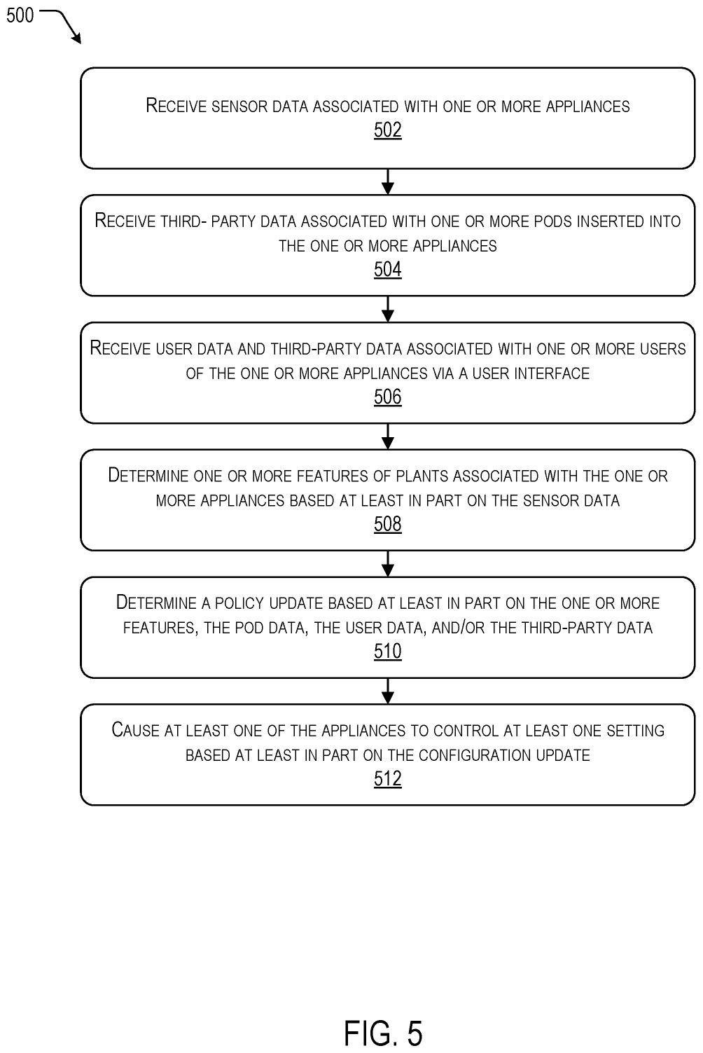

FIGS. 5-7 are flow diagrams illustrating example processes associated with the management system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 5 is an example flow diagram showing an illustrative process for updating a policy or configuration associated with the management system according to some implementations. As discussed above, the management system may be configured to adjust parameters of an indoor growing appliance having an enclosed growing environment. In some case, the management system may be a cloud based service that utilizes aggregated data across multiple growing appliances as well as personal data from each user and each appliance to generate customized parameters for each individual plant or receptacle (e.g., growing area) within the enclosed growing environment.

At 502, the management system may receive sensor data associated with one or more appliances. As discussed herein, the sensor data may include temperature data, image data, light data, and the like associated with the appliance. In some cases, the sensor data may also include water data, such as incoming water supply quality data, sequestered water data (e.g., water being sequestered by the appliance prior to introduction into the recirculating water supply-to, for instance, remove heavy metals and the like), and the dispensed or recirculating water data. The sensor data may also include air quality data that may include multiple stages of air, such as incoming air supply quality data, sequestered air data (e.g., air being sequestered by the appliance prior to introduction into the appliance air supply), and the dispensed or recirculating air data. In some cases, the sensor data may also include data associated with an environment surrounding or exterior to the appliance.

At 504, the management system may receive cartridge data associated with one or more cartridges inserted into the one or more appliances. The cartridge data may be received from third-party systems (such as supplier systems, manufacturer systems, transportation systems, and/or other processing systems) as well as from the appliances. For example, the cartridge data may include plant species, family, expected germination rate, country of origin, growing or cartridge packing facility, seed insertion and/or packaging date and/or time stamps, manufacturer demographic data, polymer demographics and manufacturing origin and date, seed insertion and/or packaging location, seed insertion and/or packaging conditions, planting location, harvest time and location, expected germination rate, expected germination time, expected growth time, historical germination time or growth time per plant species, and the like. Also, fertilizer supplier formulation and concentration quantities, growing media material properties, intended consumer demographic information, distributor demographic data, material properties, expected material degradation rate, material degradation location, tracking of nutritional deficiencies, pests, and/or plant diseases, tracking of cartridge reaction to water chemistry (e.g., inopportune water chemistry, changes in water chemistry, and the like). Some cartridge data may be assigned to that specific cartridge identifiers for variables, such as consumer reaction to plant taste, nutrition, textures, color, and the like.

At 506, the management system may receive user data and third-party data associated with one or more users of the one or more appliances via a user interface. The user data may include settings from user devices associated with the user, such as preferences of the user (e.g., plant taste, plant color, leaf size at consumption, plant age or life cycle at consumption, and the like), desired plant size, desired plant types (species or family), favorite recipes, favorite seasonings, cooking or preparation styles, food pairings, and the like. The third-party data may include data from third party applications (e.g., social media applications, marketplaces applications, smart home applications, and the like that the user has authorized the management system to access and/or communicate with) associated with the user or other users growing similar combinations of plants.

At 508, the management system may determine one or more features of plants associated with the one or more appliances based at least in part on the sensor data. For example, the management system may utilize one or more machine learned models to determine features, such as health, size, quality, color, type, germination, growth stage, growth rate, and the like.

At 510, the management system may determine a configuration update based at least in part on the one or more features, the cartridge data, the user data, and/or the third-party data. For example, the system may determine if the user preferences match the expected output of the appliances for one or more cartridges. As another example, the management system may determine if an estimated nutritional value of the plants are within a desired range as indicated by the third-party data (e.g., user health data).

At 512, the management system may cause at least one of the appliances to control at least one setting based at least in part on the configuration update. For example, the management system may push the configuration update to selected appliances or groupings of appliances to cause them to change one or more growing conditions based on the configuration update, as discussed herein.

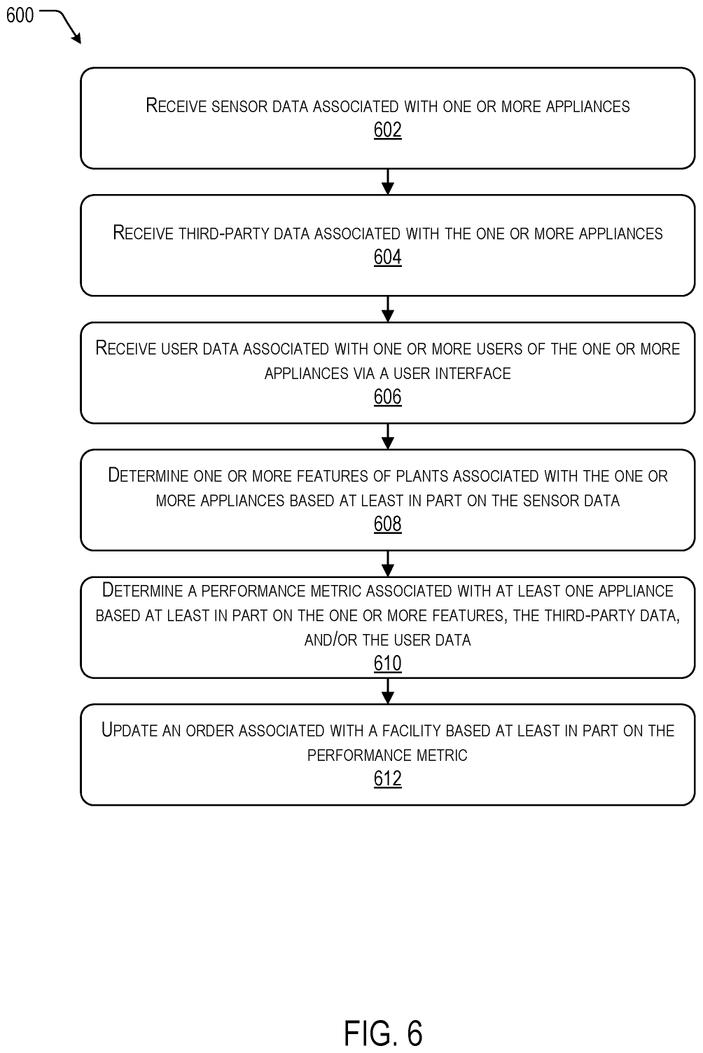

FIG. 6 is an example flow diagram showing an illustrative process for updating ordering instructions associated with the management system according to some implementations. As discussed above, the management system may be configured to track performance of suppliers, manufacturers, and/or growers associated with the cartridges made available for the growing appliances. In some case, the management system may be a cloud based service that utilizes aggregated data across multiple growing appliance as well as personal data from each user and each appliance to assist in evaluating a quality of the cartridges produced by different suppliers, manufacturers, growers and/or a combination thereof.

At 602, the management system may receive sensor data associated with one or more appliances. As discussed herein, the sensor data may include temperature data, image data, light data, and the like associated with the appliance. In some cases, the sensor data may also include water data, such as incoming water supply quality data, sequestered water data (e.g., water being sequestered by the appliance prior to introduction into the recirculating water supply-to, for instance, remove heavy metals and the like), and the dispensed or recirculating water data. The sensor data may also include air quality data that may include multiple stages of air, such as incoming air supply quality data, sequestered air data (e.g., air being sequestered by the appliance prior to introduction into the appliance air supply), and the dispensed or recirculating air data. In some cases, the sensor data may also include data associated with an environment surrounding or exterior to the appliance.

At 604, the management system may receive third-party data associated with one or more appliances. The third-party data may be received from third-party systems (such as social media, marketplaces, universities, health care providers, supplier systems, manufacturer systems, transportation systems, and/or other systems) as well as from the appliances.

At 606, the management system may receive user data associated with one or more users of the one or more appliances via a user interface. The user data may include settings from user devices associated with the user, such as preferences of the user (e.g., plant taste, plant color, leaf size at consumption, plant age or life cycle at consumption, and the like), desired plant size, desired plant types (species or family), favorite recipes, favorite seasonings, cooking or preparation styles, food pairings, and the like.

At 608, the management system may determine one or more features of plants associated with the one or more appliances based at least in part on the sensor data. For example, the management system may utilize one or more machine learned models to determine features, such as health, size, quality, color, type, germination, growth stage, growth rate, pest infiltration, and the like. In some cases, the management system may segment and/or classify image data associated with the sensor data received from the one or more appliances to identify individual regions, plants, or features within the growing environment as well as to assign identifiers (such as plant species, parts, and the like).

At 610, the management system may determine a performance metric (such as a germination rate or yield rate) associated with at least one appliance (or an individual cartridge) based at least in part on the one or more features, the third-party data, and/or the user data. For example, the system may determine a quality of a plant associated with a particular appliance using the third-party data and the one or more features as well as one or more machine learned models. In some cases, the system may determine a performance of a suppliers, manufacturers, and/or growers based on the quality of the plants associated with cartridges prepared and/or shipped by the manufacturer. For example, the sensor data may include image data that allows the management system to determine the suppliers, manufacturers, and/or growers (such as via a marking on the cartridge or cartridge lid). The system may then associate the performance of the cartridge with the suppliers, manufacturers, and/or growers based on, for instance, an aggregated performance of the cartridge associated with each suppliers, manufacturers, and/or growers in the appliances.

In some cases, the system may also associate particular policies or parameters with cartridges produced by individual suppliers, manufacturers, and/or growers in a manner similar to plant species, subspecies, genus, botanical variety, types, or the like.

At 612, the management system may then update an order (such as an amount) associated with a facility (such as a supplier, manufacturer, and/or grower) based at least in part on the performance metric. For example, the management system may reduce an order amount if the yield rate, health metric, or quality metric of cartridges associated with a facility are below a threshold.

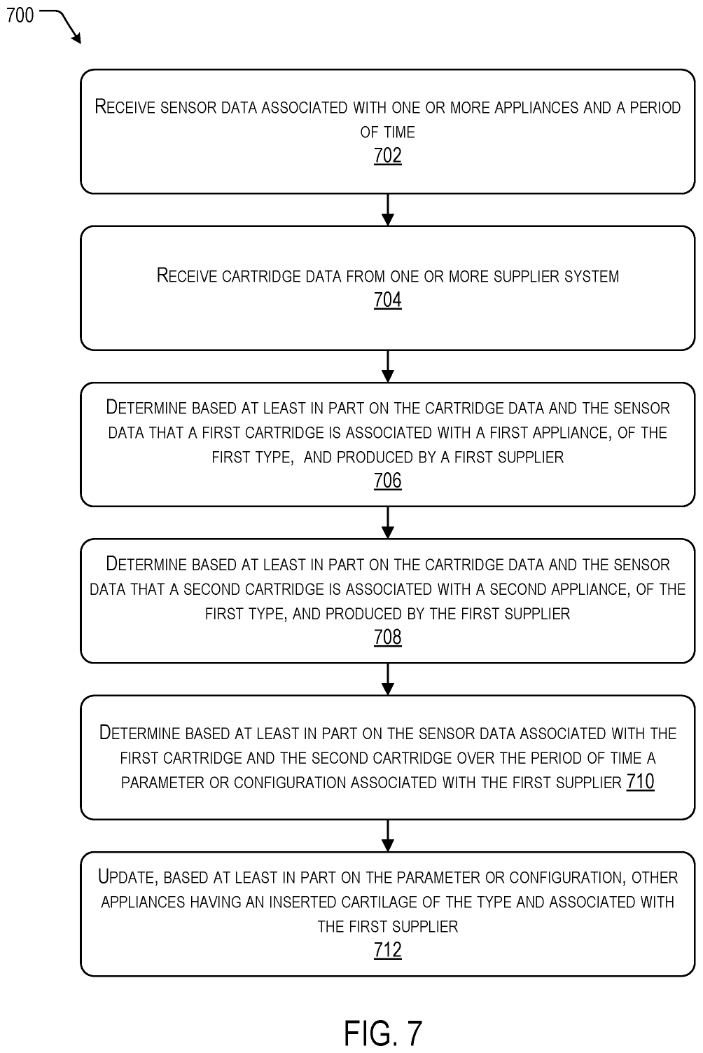

FIG. 7 is an example flow diagram showing an illustrative process for updating parameters associated with the management system according to some implementations. As discussed above, the management system may be configured to track performance of suppliers, manufacturers, and/or growers associated with the cartridges made available for the growing appliances. In some case, the management system may be a cloud based service that utilizes aggregated data across multiple growing appliance as well as personal data from each user and each appliance to generate customized parameters for each individual plant or receptacle (e.g., growing area) within the enclosed growing environment based on the individual suppliers, manufacturers, and/or growers that produced each the cartridge.

At 702, the management system may receive sensor data associated with one or more appliances over a period of time. As discussed herein, the sensor data may include temperature data, image data, light data, and the like associated with the appliance. In some cases, the sensor data may also include water data, such as incoming water supply quality data, sequestered water data (e.g., water being sequestered by the appliance prior to introduction into the recirculating water supply-to, for instance, remove heavy metals and the like), and the dispensed or recirculating water data. The sensor data may also include air quality data that may include multiple stages of air, such as incoming air supply quality data, sequestered air data (e.g., air being sequestered by the appliance prior to introduction into the appliance air supply), and the dispensed or recirculating air data. In some cases, the sensor data may also include data associated with an environment surrounding or exterior to the appliance. In some cases, the period of time may be a period associated with a planting, cultivation, and/or harvesting of a plant with respect to a growing appliance. In other cases, the period of time may be a predetermined period of time, such as a week, month, quarter, and the like.

At 704, the management system may receive cartridge data from one or more manufacturer and/or supplier system. The cartridge data may include plant species, family, expected germination rate, growth facility, seed insertion and/or packaging date and/or time stamps, manufacturer demographic data, seed insertion and/or packaging location, seed insertion and/or packaging conditions, expected germination rate, expected germination time, expected growth time, historical germination time or growth time per plant species, and the like.

At 706, the management system may determine based at least in part on the cartridge data and the sensor data that a first cartridge is associated with a first appliance, is of the first type, and is produced by a first supplier, manufacturer, and/or grower. For example, the system may utilize image data received as part of the sensor data to identify a specific cartridge associated with a specific supplier, manufacturer, grower, and/or combination thereof. In other cases, the user may provide an identifier associated with the supplier, manufacturer, grower, and/or combination thereof via a user interface as discussed above. The user may also provide a location or receptacle the cartridge was inserted into to assist the management system in determining the first cartridge is associated with the first appliance, is of the first type, and is produced by the first supplier, manufacturer, and/or grower.

At 708, the management system may determine based at least in part on the cartridge data and the sensor data that a second cartridge is associated with a second appliance, is of the first type, and is produced by the first supplier, manufacturer, and/or grower. For example, the system may again utilize image data received as part of the sensor data from the second appliance to identify a specific cartridge associated with a specific supplier, manufacturer, grower, and/or combination thereof. In other cases, the user may provide an identifier associated with the supplier, manufacturer, grower, and/or combination thereof via a user interface as discussed above. The user may also provide a location or receptacle the cartridge was inserted into to assist the management system in determining the first cartridge is associated with the first appliance, is of the first type, and is produced by the first supplier, manufacturer, and/or grower.

At 710, the management system may determine based at least in part on the sensor data associated with the first cartridge and the second cartridge over the period of time a parameter or configuration associated with the first supplier, manufacturer, and/or grower. For example, the system may determine that the first cartridge produced a higher quality plant than the second cartridge. The system may then determine differences in the parameters between the first and second appliance and associated with the first and second cartridges. The system may then determine a parameter adjustment based at least in part on the differences. In some cases, the management system may test the new parameters on additional appliances with cartridges having the same type, supplier, manufacturer, grower, and the like to determine a consistency of the results upon applying the new parameters.

At 712, the system may update, based at least in part on the parameter or configuration, other appliances having an inserted cartridge of the type and associated with the first supplier, manufacturer, and/or grower. For example, upon detecting of a seed cartridge associated with the supplier, manufacturer, and/or grower and having the same type as the first cartridge and the second cartridge in additional appliances, the management system may apply the configuration and/or parameters that produced the higher quality harvest.

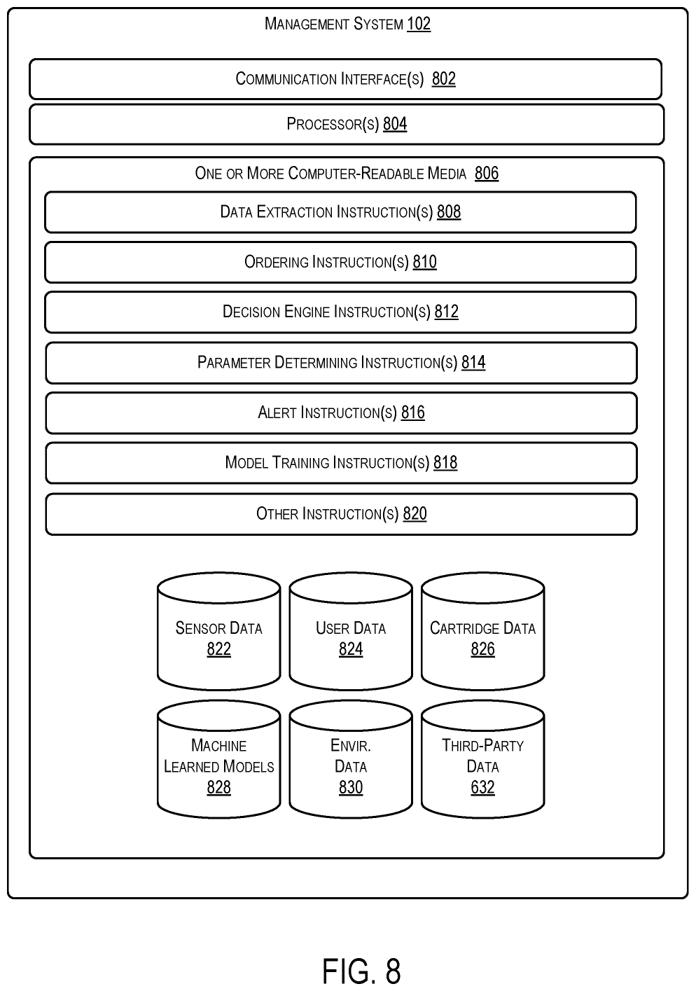

FIG. 8 is an example diagram of a cloud-based service associated with the management system 102 according to some implementations. The management system 102 may include one or more communication interface(s) 802 (also referred to as communication devices and/or modems). The one or more communication interfaces(s) 802 may enable communication between the management system 102 and one or more other local or remote computing device(s) or remote services. For instance, the communication interface(s) 802 can facilitate communication with other sensor systems, appliances, user interfaces, and/or other third-party systems. The communications interfaces(s) 802 may enable Wi-Fi-based communication such as via frequencies defined by the IEEE 802.11 standards, short range wireless frequencies such as Bluetooth, cellular communication (e.g., 2G, 3G, 4G, 5G, 4G LTE, 6G, etc.), satellite communication, dedicated short-range communications (DSRC), ethernet, or any suitable wired or wireless communications protocol that enables the respective computing device to interface with the other computing device(s).

The management system 102 may include one or more processor(s) 804 and one or more computer-readable media 806. Each of the processors 804 may itself comprise one or more processors or processing cores. The computer-readable media 806 is illustrated as including memory/storage. The computer-readable media 806 may include volatile media (such as random access memory (RAM)) and/or nonvolatile media (such as read only memory (ROM), Flash memory, optical disks, magnetic disks, and so forth). The computer-readable media 806 may include fixed media (e.g., GPU, NPU, RAM, ROM, a fixed hard drive, and so on) as well as removable media (e.g., Flash memory, a removable hard drive, an optical disc, and so forth). The computer-readable media 806 may be configured in a variety of other ways as further described below.

Several modules such as instructions, data stores, and so forth may be stored within the computer-readable media 806 and configured to execute on the processors 804. For example, as illustrated, the computer-readable media 806 stores data extraction instructions 808, ordering instructions 810, decision engine instructions 812, parameter determining instructions 814, alert instructions 816, model training instructions 818 as well as other instructions 820, such as an operating system. The computer-readable media 806 may also be configured to store data, such as sensor data 822, user data 824, cartridge data 826, machine learned models 828, environmental data 830, and/or third-party data 632 as well as other types of data.

The data extraction instructions 808 may be configured to determine features associated with a growing appliance, inserted cartridges, or developing plants. In some cases, the data extraction instructions 808 may utilize one or more machine learned models and/or networks to parse, segment, and/or classify data, such as image data, captured with respect to the interior of a growing appliance. For example, the data extraction instructions 808 may determine regions of the planting column, plant identifies, cartridge identifies, plant conditions (e.g., size, life stage, health, etc.), and the like.

The ordering instructions 810 may be configured to adjust order amounts from third party suppliers (such as manufacturers and growers) of cartridges. For example, the system may adjust orders of cartridges based on detected or determined germination rates, plant quality, plant health, plant yields, and the like.

The decision engine instructions 812 may also access a datastore housing configuration data to update configuration data based on received data or stored data (e.g., user data, sensor data, third party data, cartridge data, and the like) and one or more machine learned models or networks. For example, the decision engine instructions 812 may apply a multi-arm bandit technique to the received data in order to update the configuration data to assist with improving the overall yield, output, and quality of the plants grown in the appliances to meet the user preference data requirements.

The parameter determining instructions 814 may be configured to determine parameters to improve the overall yield, output, and quality of the plants grown in the appliances to meet the user preference data requirements based on user data, sensor data, third party data, cartridge data associated with multiple users and appliances. In some cases, the data may be aggregated prior to determining the parameters. In some cases, the parameter determining instructions 814 may select and apply new parameters and/or policies to different appliances in order to confirm a consistency of the improved quality, yields, and/or output of the plants based on the application of the parameter, policy, and/or configuration.

The alert instructions 816 may be configured to provide alerts to a user interface related to plants, cartridges, appliances, and the like. For example, the alert instructions 816 may include an alert to a user to harvest a particular plant within an appliance. As another example, the alert instructions 816 may send an alert to a user interface to inform a user of a change in parameters, policies, or the like with respect to their appliance. In some cases, the alert instructions 816 may process user responses to the alert such as confirmation or acceptance as well as a rejection of the change in parameters, policy, and/or configuration.

The model training instructions 818 may be configured to train the machine learned models 828 based on training data and/or user inputs.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A method comprising:
receiving first sensor data from a first sensor of a first system, the first sensor data representing a first region associated with a first enclosure of the first system, the first enclosure configured to provide a first controlled physical environment;
determining, based at least in part on the first sensor data, a first feature associated with a first plant inhabiting the first region;
determining, based at least in part on the first feature, at least one first setting for the first system; and
causing the first system to apply the at least one setting to the first region.

2. The method of claim 1, further comprising:
receiving second sensor data from a second sensor of a second system, the second sensor data representing a second region associated with a second enclosure of the second system, the second enclosure configured to provide a second controlled physical environment;
determining, based at least in part on the second sensor data, a second feature associated with a second plant inhabiting the second region; and
wherein determining the at least one first setting for the first system is based at least in part on the second feature.

3. The method of claim 2, further comprising
receiving first cartridge data from a first third party system, the first cartridge data representing data and an identity of a first seed cartridge;
determining, based at least in part on the sensor data and the first cartridge data, that the first seed cartridge is associated with the first region;
determining, based at least in part on the sensor data, a first metric associated with the first third party system; and
adjusting, based at least in part on the first metric, an order for additional seed cartridges with the first third party system.

4. The method of claim 2, further comprising
receiving second cartridge data from the first third party system, the second cartridge data representing data and an identity of a second seed cartridge;
determining, based at least in part on the second sensor data and the second cartridge data, that the second seed cartridge is associated with the second region;
determining, based at least in part on the second sensor data, a second metric associated with the first third party system; and
adjusting, based at least in part on the second metric, the order for the additional seed cartridges with the first third party system.

4. The method of claim 3, further comprising:
receiving first third party data from a second third party system, the first third party data; and
wherein determining the at least one first setting for the first system is based at least in part on the first third party data, the first cartridge data, and the feature.

5. The method of claim 1, wherein the first feature includes one or more of:
a health of the first plant;
a life stage of the first plant;
a size of the first plant; and
a classification or type of the first plant.

6. The method of claims 1, wherein:
the first system includes a planting column configured to rotate about a vertical axis within the enclosure, and
the first region is associated with a receptacle of the planting column.

7. The method of claims 1, wherein determining the at least one first setting for the first system further comprises:
inputting the first sensor data into one or more machine learned models or networks; and
receiving the at least one first setting as an output from the one or more machine learned models or networks.

8. The method of claims 1, further comprising:
receiving user data from a user device; and
wherein determining the at least one first setting for the first system is based at least in part on the user data and the feature.

9. A system comprising:
one or more processors; and
one or more non-transitory computer readable media storing instructions executable by the one or more processors, wherein the instructions, when executed, cause the system to perform operations comprising:
receiving first sensor data from a first sensor of a first system, the first sensor data representing a first region associated with a first enclosure of the first system, the first enclosure configured to provide a first controlled physical environment;
receiving second sensor data from a second sensor of a second system, the second sensor data representing a second region associated with a second enclosure of the second system, the second enclosure configured to provide a second controlled physical environment;
determining, based at least in part on the first sensor data and the second sensor data, at least one parameter for the first system; and
sending the at least one parameters to the first system.

10. The system of claim 9, wherein
receiving user data from a user device;
receiving first third party data from a first third party system; and
wherein determining the at least one first parameter for the first system is based at least in part on the user data and the first third party data.

11. The system of claim 9, wherein
receiving first cartridge data from a first third party system, the first cartridge data representing data and an identity of a first seed cartridge;
determining, based at least in part on the first sensor data and the first cartridge data, that the first seed cartridge is associated with the first third party system;
determining, based at least in part on the first sensor data, a first metric associated with the first third party system; and
adjusting, based at least in part on the first metric, an order for additional seed cartridges with the first third party system.

12. The system of claim 11, wherein the operations further comprise:
receiving second cartridge data from the first third party system, the second cartridge data representing data and an identity of a second seed cartridge;
determining, based at least in part on the second sensor data and the second cartridge data, that the second seed cartridge is associated with the second region;
determining, based at least in part on the second sensor data, a second metric associated with the first third party system; and
adjusting, based at least in part on the second metric, the order for the additional seed cartridges with the first third party system.

13. The system of claim 9, wherein the operations further comprise:
determining, based at least in part on the first sensor data, a first feature associated with a first plant inhabiting the first region; and
wherein determining the least one parameter for the first system is based at least in part on the first feature.

14. The system of claim 13, wherein determining, based at least in part on the first sensor data, a first feature associated with a first plant inhabiting the first region further comprises:
inputting the first sensor data into one or more machine learned models or networks; and
receiving the first feature as an output from the one or more machine learned models or networks.

15. A system comprising:
a gateway system for receiving at least first sensor data from a first growing appliance, second sensor data from a second growing appliance, and sending configuration updates to the first growing appliance and the second growing appliance;
a sensor data processing system to segment or classify the first sensor data and the second sensor data;
a decision system to determine the configuration update based at least in part on the output of the sensor data processing system.

16. The system of claim 15, wherein:
the gateway system is further configured to receive seed cartridge data and user input data; and
the decision system is further configured to determine the configuration update based at least in part on the seed cartridge data and the user data.

17. The system of claim 16, wherein the user data includes at least one criteria for a plant associated with the first appliance or the second appliance.

18. The system of claim 17, wherein the at least one criteria includes at least one of
a water preference,
an environmental preference,
a lighting preference,
an algae preference,
a harvesting preference,
a tissue metric preference,
a size preference, or
a nutrition metric preference.

19. The system of claim 16, wherein the sensor data processing system is further configured to determine, based at least in part on the cartridge data and the first sensor data or the second sensor data, a third party associated with producing a seed cartridge of a plant housed within the first appliance or the second appliance.

20. The system of claim 19, wherein the system adjusts an order associated with the third party in response to determining the third party is associated with producing the seed cartridge of the plant housed within the first appliance or the second appliance.
